(19) United States
(12) Patent Application Publication
(10) Pub. No.: US 2006/0106761 A1
(43) Pub. Date: May 18, 2006

(54) Remote detection of a fault condition of a management application using a networked device

(76) Inventor: Parthasarathy Sarangam, Portland, OR (US)

Correspondence Address: Grossman, Tucker, Perreault & Pfleger, PLLC;PortfolioIP, P.O. Box 52050, Minneapolis, MN, 55402, US

(21) Appl. No.: 10/977,578

(22) Filed: Oct. 29, 2004

(51) Int. Cl. G06F 7/00; G06F 17/30

(52) U.S. Cl. 707/3

(57) ABSTRACT

A method according to one embodiment may include monitoring a management application of a managed client for a fault condition, and transmitting an alert signal representative of the fault condition to a management server only in response to the monitoring operation detecting the fault condition. Of course, many alternatives, variations, and modifications are possible without departing from this embodiment.

### FIELD

This disclosure relates to remote detection of a fault condition of a management application using a networked device.

### BACKGROUND

A variety of devices such as personal computers (PCs), printers, servers, and other networked devices may exchange data and/or commands with each other over an associated network, e.g., a local area network (LAN), utilizing a variety of communication protocols. Such networked devices may each have a network controller to provide a connection between the device and the associated network.

Various devices in the network may also have various management software applications. An information technology (IT) administrator for the network may utilize such management software applications to remotely perform a variety of management and monitoring functions. Such functions may include, but not be limited to, detecting problems in a managed client, collecting system inventory data, upgrading operating systems of various managed clients, upgrading various applications, and updating virus signature files. Several of such management applications must continuously run, e.g., to ensure that operating system versions and anti-virus files are up to date. However, a variety of problems such as software, hardware, network problems, and/or user error may cause such management applications to stop running. If a management application of a particular managed client stopped running, it would be desirable to inform an IT administrator so that the IT administrator may then take some corrective action as appropriate to remedy the situation.

One conventional method of notifying an IT administrator if a management application of a particular managed client has stopped running is for each management application of each managed client of the network to periodically send “heartbeat” messages over the network to a management server that can monitor such “heartbeat” messages. If a management application of a managed client is not sending the expected “heartbeat” messages, the management server assumes that the corresponding application has stopped running and may then notify the IT administrator.

This conventional method suffers from several drawbacks. First, each monitored application of each managed client must send such “heartbeat” messages over the network. This increases low-content network traffic that can degrade speed performance of the network. Second, when managed clients are shut down or in a low-power state, their management applications may not be able to send “heartbeat” messages to the management station. This requires the management station to keep track of the state of every managed client to avoid sending false alarms of an application termination. Third, some management applications may utilize a connection oriented protocol such as Transmission Control Protocol (TCP) to guarantee the delivery of “heartbeat” messages that may not be guaranteed using a connection less transport protocol such as User Datagram Protocol (UDP). However, the management applications utilizing a connection oriented protocol such as TCP must constantly maintain a network connection with the management server. In this instance, the potentially large number of “always-on” network connections may then limit the number of managed clients a given management server can monitor.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram illustrating a system embodiment;

FIG. 2 is a diagram illustrating in greater detail a managed client of the system of FIG. 1; and

FIG. 3 is a block diagram and flow chart detailing operations of the managed client of FIG. 2;

FIG. 4 is a block diagram of one embodiment of an alert signal; and

FIG. 5 is a flow chart illustrating operations according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

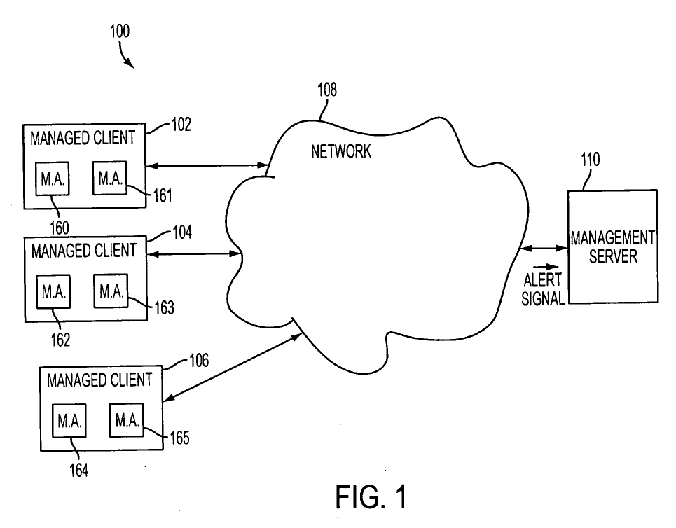

FIG. 1 illustrates a system 100 consistent with an embodiment. The system 100 may include a plurality of managed clients 102, 104, 106, and a management server 110 that may exchange data and/or commands with each other via a network 108. One or more management applications may be running on each managed client. For example, this may include management applications 160, 161 for managed client 102, management applications 162, 163 for managed client 104, and management applications 164, 165 for managed client 106. As used herein, a “management application” may comprise software that performs system management functions for a managed client.

An IT administrator may utilize the management server 110 and the management applications of each managed client 102, 104, 106 to remotely perform a variety of management functions for each managed client including, but not limited to, collecting system inventory data, upgrading operating systems of various managed clients, upgrading various applications, and updating virus signature files. Many of these management applications should continuously run to ensure adequate network system performance, e.g., to ensure that operating system versions and anti-virus files are up to date for each managed client 102, 104, 106. To assist with the monitoring of certain management applications, each managed client 102, 104, 106 may monitor one or more of its management applications, and advantageously be adapted to transmit an alert signal representative of a fault condition via the network 108 to the management server 110 only in response to the monitoring operation detecting a fault condition.

Communication between managed clients 102, 104, 106 and management server 110 via the network 108 may comply or be compatible with a variety of communication protocols. One such communication protocol may comply or be compatible with an Ethernet protocol and the network 108 may be a local area network (LAN). The Ethernet protocol may comply or be compatible with the Ethernet standard published by the Institute of Electrical and Electronics Engineers (IEEE) titled the IEEE 802.3 standard, published in March, 2002 and/or later versions of this standard.

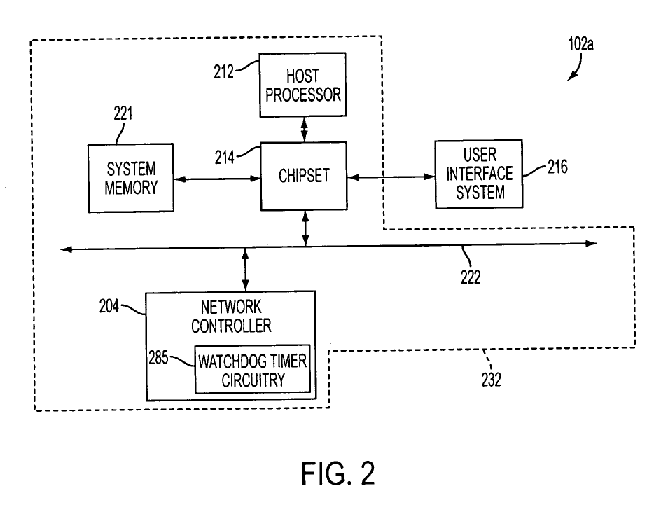

FIG. 2 is a block diagram of one embodiment 102a of the managed client 102 of the system of FIG. 1. The managed client 102a may include a host processor 212, a bus 222, a user interface system 216, a chipset 214, system memory 221, and a network controller 204. The host processor 212 may include one or more processors known in the art such as an Intel® Pentium® IV processor commercially available from the Assignee of the subject application. The bus 222 may include various bus types to transfer data and commands. For instance, the bus 222 may comply with the Peripheral Component Interconnect (PCI) Express Base Specification Revision 1.0, published Jul. 22, 2002, available from the PCI Special Interest Group, Portland, Oreg., U.S.A. (hereinafter referred to as a “PCI Express™ bus”). The bus 222 may alternatively comply with the PCI-X Specification Rev. 1.0a, Jul. 24, 2000, available from the aforesaid PCI Special Interest Group, Portland, Oreg., U.S.A. (hereinafter referred to as a “PCI-X bus”).

The user interface system 216 may include one or more devices for a human user to input commands and/or data and/or to monitor the system, such as, for example, a keyboard, pointing device, and/or video display. The chipset 214 may include a host bridge/hub system (not shown) that couples the processor 212, system memory 221, and user interface system 216 to each other and to the bus 222. The chipset 214 may include one or more integrated circuit chips, such as those selected from integrated circuit chipsets commercially available from the Assignee of the subject application (e.g., graphics memory and I/O controller hub chipsets), although other integrated circuit chips may also, or alternatively be used. The network controller 204 may enable bi-directional communication between the managed client 102a and other networked devices coupled to the network 108 including the management server 110. The network controller 204 may also be electrically coupled to the bus 222 and may exchange data and/or commands with system memory 221, host processor 212, and/or user interface system 216 via the bus 222 and chipset 214.

The network controller 204 may include a variety of circuitry including watchdog timer circuitry 285. Although only one watchdog time circuitry 285 is illustrated for clarity, a plurality of watchdog timer circuitries may be comprised in the network controller 204. As used herein, “circuitry” may comprise, for example, singly or in any combination, hardwired circuitry, programmable circuitry, state machine circuitry, and/or firmware that stores instructions executed by programmable circuitry. A variety of software may also be installed and running on the managed client 102a such as one or more management applications and a device driver that may provide an interface between the monitored management application and the watchdog timer circuitry 285.

The managed client 102a may include any variety of machine readable media such as system memory 221. Machine readable program instructions may be stored in any variety of such machine readable media so that when the instructions are executed by a machine, e.g., by the processor 212 in one instance, or circuitry in another instance, etc., it may result in the machine performing operations described herein. In addition, such program instructions, e.g., machine-readable firmware program instructions, may be stored in other memory locals that may be accessed and executed by the machine to perform operations described herein as being performed by the machine.

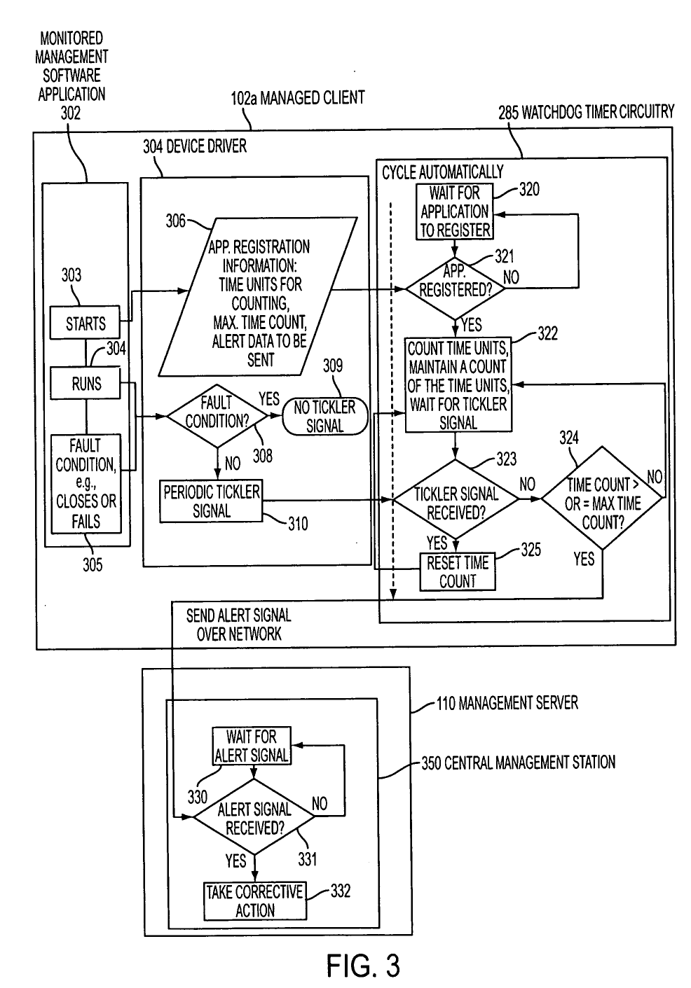

FIG. 3 is a block diagram illustrating the managed client 102a of FIG. 2 that is capable of communicating with the management server 110 via the network 108. Only one managed client 102a with reference to one monitored management software application 302 is detailed in FIG. 3, although a system consistent with additional embodiments may include a plurality of managed clients with each managed client having a plurality of monitored management software applications.

The managed client 102a may include a monitored management software application 302, a device driver 304, and a particular watchdog timer circuitry 285. The watchdog timer circuitry 285 may be comprised in the network controller 204 as illustrated in FIG. 2. The network controller 204 may include one or more watchdog timer circuitries. The device driver 304 may serve as an intermediary between the monitored management application 302 and the watchdog timer circuitry 285.

In operation, upon start up of the managed client 102a, a boot process may start the monitored management application 302 in operation 303 and the application may run in operation 304 or encounter a fault condition in operation 305. A fault condition may include, but not be limited to, a closing of the application, a failure of the application, and/or termination of the application. At the start of the monitored management application in operation 303, the application 302 may register, via the device driver 304 and operation 306, with the network controller 204 for a particular watchdog timer circuitry, e.g., circuitry 285. The application registration information that may be ascertained in operation 306 may include, but not be limited to, time units (e.g., clock cycles) for counting by the watchdog timer circuitry, the maximum time count, and particular alert data to be sent with any alert signal if the time count reaches the maximum time count value.

Operation 308 may determine whether or not the management application 302 has experienced a fault condition. In one instance, this may be determined by the management software application 302 sending periodic signals to the device driver 304 if there is no fault condition and failing to send such periodic signals if there is a fault condition. If there is a fault condition, then the device driver may not send a periodic tickler signal in operation 309. However, if there is no fault condition, the device driver may send a periodic tickler signal in operation 310.

In operation 321, the watchdog timer circuitry 285 may determine if a particular management application has registered with it. If not, the watchdog timer circuitry 285 may wait until a management application does register with it in operation 320. Once a management application has registered with the watchdog timer circuitry, it may then in operation 322 start to count time units (e.g., clock cycles), maintain a count of the time units, and wait for a tickler signal from the device driver 304 indicating that there is no fault condition in the monitored management application 302.

Operation 323 of the watchdog timer circuitry 285 inquires whether the tickler signal has been received. If the tickler signal has been received, the watchdog timer circuitry 285 may reset its time count in operation 325 and cycle back to operation 322 to start the time counting process again. However, if the tickler signal is not received, operation 324 inquires whether the time count has reached the maximum time count value. If it has not, then watchdog timer circuitry 285 continues to count time in operation 322. If no tickler signal is received by the watchdog timer circuitry 285 and the time count equals or exceeds the maximum time count value, then an alert signal may be sent via the network to the central management station 350 of the management server 110, e.g., by the network controller 204 comprising the watchdog timer circuitry 285. Therefore, the network controller 204 does not send an alert signal over the network 108 to the management server 110 if there is no fault condition and it continues to receive the tickler signal before the time count reaches a maximum time count value.

The periodic tickler signal in operation 310 may be generated in response to a management application utilizing an operating system (OS) resident timer. It is possible under certain conditions, e.g., when there is a high amount of activity in the system, that the OS resident timer may be delayed and the tickler signal may fail to be sent in operation 310 to the watchdog timer circuitry 285. To account for this, the maximum time count value may be specifically chosen to be a relatively larger time count value. Alternatively, if a relatively lower maximum time count value is selected, the watchdog timer circuitry 285 may be adapted to wait for consecutive expirations of the maximum time count value, e.g., 3, before sending the alert signal. The maximum time count value may vary considerably depending, at least in part, on the criticality of the monitored management application and the other considerations of an IT administrator. In some embodiments, a range of maximum time count values may be between 60 seconds and 1 hour. Such maximum time count values may be set by an IT administrator.

The central management station 350 inquires whether an alert signal is received in operation 331. Any one of a plurality of alert signals from any plurality of network controllers may be received regarding a fault condition of any one of a plurality of monitored management applications.

If an alert signal is not received in operation 331, the central management station 350 may continue to wait for an alert signal in operation 330. If in alert signal is received, then corrective action may be taken in operation 322. Such corrective action may include, but not be limited to, providing notice to an IT administrator who may then take appropriate action, remotely repairing the management application, and/or remotely reactivating the management application from the management server 110.

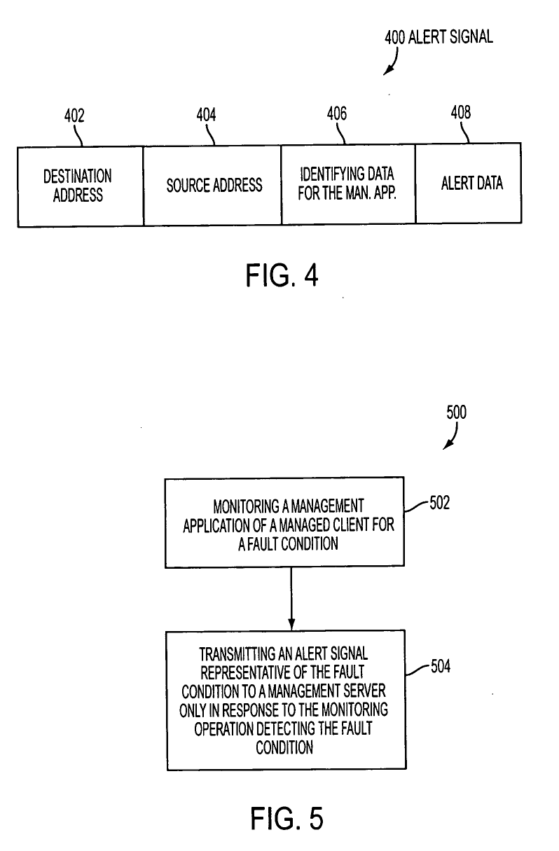

FIG. 4 illustrates an exemplary alert signal 400 that may be sent over the network 108. In general, the alert signal 400 may be representative of a fault condition of the particular monitored management application. The alert signal may comply or be compatible with any variety of communication protocols such as the Ethernet communication protocol and hence the particular format of the alert signal may vary from protocol to protocol.

For frame based communication protocols, the alert signal 400 may include one or more frames. The alert signal 400 may include a portion 402 containing the destination address of the management server 110. The destination address, e.g., the domain name server (DNS) name, of the management server 110 may be obtained by the network controller 204 any variety of ways. For example, the destination address of the management server may be pre-programmed into the network controller 204 when the managed client is installed in the network. The network controller 204 may also obtain the destination address of the management server from a dynamic host configuration protocol (DHCP) server.

The alert signal 400 may also include a portion 404 indicating the source address of the particular managed client sending the alert signal. In addition, the alert signal may also include another portion 406 containing identifying data that identifies the particular management application of the managed client that has experienced a fault condition. Hence, the alert signal 400 may inform the management server 110 which managed client and which management application of that client has experienced the fault condition. Furthermore, the alert signal may contain alert data 408. This alert data 408 may be the data that was specified to be sent by the application registration process in operation 306 (see FIG. 3). Such alert data 408 may be used by appropriate IT personnel to efficiently identify and correct problems of the management application.

FIG. 5 is a flow chart of exemplary operations 500 consistent with an embodiment. Operation 502 may include monitoring a management application of a managed client for a fault condition. Operation 504 may include transmitting an alert signal representative of the fault condition to a management server only in response to the monitoring operation detecting the fault condition.

It will be appreciated that the functionality described for all the embodiments described herein, may be implemented using hardware, firmware, software, or a combination thereof.

Thus, in summary, one embodiment may comprise an apparatus. The apparatus may comprise a network controller capable of transmitting an alert signal representative of a fault condition of a management application to a management server only in response to a monitoring operation detecting the fault condition.

Another embodiment may comprise a system. The system may comprise a managed client comprising a network controller coupled to a bus, and at least one management application adapted to run on the managed client. The network controller may be capable of transmitting an alert signal representative of a fault condition of the at least one management application to a management server only in response to a monitoring operation detecting the fault condition.

Yet another embodiment may include an article. The article may comprise a machine readable medium having stored thereon instructions that when executed by a machine results in the following: monitoring a management application of a managed client for a fault condition; and transmitting an alert signal representative of the fault condition to a management server only in response to the monitoring operation detecting the fault condition.

Advantageously, in these embodiments, the managed client need only send an alert signal upon detection of a fault condition of a management application of a particular managed client. Therefore, no alert message is sent to the management server if the monitored management application is running properly. Hence, the amount of traffic on the network is reduced compared to a conventional method that sends periodic and constant “heartbeat” messages to the management server when a monitored management application is running properly. In addition, these embodiments also enable one management server to simultaneously manage a plurality of management applications from a plurality of managed clients without burdening the associated network with excess amounts of increased traffic.

In addition, the management server does not need to keep track of a power state of each managed client (e.g., shut down state or low power state) in order to avoid false alert signals. If the managed client is in a shut down or low power state and the management application is not running, the monitoring operation will not detect a fault condition and hence no false alert signals may be sent. Furthermore, there is no need to maintain an “always-on” connection between the managed client and the management server. Accordingly, an increased plurality of management applications can be monitored simultaneously without burdening the network with excessive traffic.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method comprising:
monitoring a management application of a managed client for a fault condition; and
transmitting an alert signal representative of said fault condition to a management server only in response to said monitoring operation detecting said fault condition.

2. The method of claim 1, wherein said fault condition comprises termination of said management application.

3. The method of claim 1, wherein said monitoring operation comprises counting time units, maintaining a count of said time units, and resetting said count in response to a tickler signal representative of an absence of said fault condition.

4. The method of claim 3, further comprising transmitting said alert signal only if said count becomes greater than or equal to a maximum time count.

5. The method of claim 1, wherein said alert signal is sent to said management server via a network and said alert signal complies with an Ethernet communication protocol.

6. The method of claim 1, further comprising simultaneously monitoring a plurality of management applications from any of a plurality of managed clients, and wherein said alert signal identifies a particular one of said management applications of a particular one of said managed clients having said fault condition to said management server.

7. An apparatus comprising:
a network controller capable of transmitting an alert signal representative of a fault condition of a management application to a management server only in response to a monitoring operation detecting said fault condition.

8. The apparatus of claim 7, wherein said fault condition comprises termination of said management application.

9. The apparatus of claim 7, wherein said network controller comprises watchdog timer circuitry registered to said management application, said watchdog timer circuitry capable of counting time units, maintaining a count of said time units, and resetting said count in response to a tickler signal representative of an absence of said fault condition of said management application.

10. The apparatus of claim 9, wherein said network controller is further capable of transmitting said alert signal only if said count becomes greater than or equal to a maximum time count.

11. The apparatus of claim 7, wherein said alert signal comprises data identifying said management application and said managed client to said management server.

12. The apparatus of claim 7, wherein said alert signal comprises a destination address of said management server, and wherein said alert signal complies with an Ethernet communication protocol for communication over a network to said management server.

13. A system comprising:
a managed client comprising a network controller coupled to a bus, at least one management application adapted to run on said managed client, said network controller capable of transmitting an alert signal representative of a fault condition of said at least one management application toga management server only in response to a monitoring operation detecting said fault condition.

14. The system of claim 13, wherein said fault condition comprises termination of said management application.

15. The system of claim 13, wherein said network controller comprises watchdog timer circuitry registered to said at least one management application, said watchdog timer circuitry capable of counting time units, maintaining a count of said time units, and resetting said count in response to a tickler signal representative of an absence of said fault condition of said at least one management application.

16. The system of claim 15, wherein said network controller is further capable of transmitting said alert signal only if said count becomes greater than or equal to a maximum time count.

17. An article comprising:
a machine readable medium having stored thereon instructions that when executed by a machine results in the following:
monitoring a management application of a managed client for a fault condition; and
transmitting an alert signal representative of said fault condition to a management server only in response to said monitoring operation detecting said fault condition.

18. The article of claim 17, wherein said fault condition comprises termination of said management application.

19. The article of claim 17, wherein said monitoring operation comprises counting time units, maintaining a count of said time units, and resetting said count in response to a tickler signal representative of an absence of said fault condition.

20. The article of claim 19, wherein said instructions that when executed by said machine also result in transmitting said alert signal only if said count becomes greater than or equal to a maximum time count.

21. The article of claim 17, wherein said alert signal is sent to said management server via a network and said alert signal complies with an Ethernet communication protocol.
